(19) United States
(12) Patent Application Publication
(10) Pub. No.: US 2007/0201811 A1
(43) Pub. Date: Aug. 30, 2007

(54) Disc Allocation/Scheduling For Layered Video

(75) Inventor: Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/596,595

(22) PCT Filed: Dec. 3, 2004
(86) PCT No.: PCT/IB04/52652

§ 371 Date: Jun. 19, 2006

(30) Foreign Application Priority Data
Dec. 22, 2003 (EP) 03104876.2

(51) Int. Cl. H04N 5/91

(52) U.S. Cl. 386/46; 348/E05.007; 386/125

(57) ABSTRACT

A method and apparatus for recording a data stream having a base stream and an enhancement stream on a storage medium for improving non-linear playback performance of the recorded data is disclosed. The data stream is received and I-pictures from the base stream are stored in a first buffer. All of the remaining data from the data stream is stored in a second buffer. Each time the first buffer becomes full, I-pictures stored in the first buffer are written onto an intra-coded allocation unit on the storage medium. The contents of second buffer are written onto at least one subsequent inter-coded allocation unit.

### FIELD OF THE INVENTION

The invention relates to disc allocation for layered video, and more particularly to a method and apparatus for allocation and scheduling of a video stream comprised of a base stream and an enhancement stream.

### BACKGROUND OF THE INVENTION

Because of the massive amounts of data for digital video, various video compression methods are used to store the video data on a medium. It is a well know practice that these compressed video streams are stored on the medium in one resolution. When applications require non-linear access, e.g., fast forward or reverse, then this type of storage has severe drawbacks. All the stored data has to be retrieved from the storage medium at very high speeds and also the decoding needs to be at a very high speed which both lead to high costs and high power requirements.

### SUMMARY OF THE INVENTION

The invention overcomes the deficiencies of the prior systems by using a spatial layered compression method and storing the lower resolution base stream and the enhancement stream on two separate locations on the medium. By using different allocation units for storing the base and enhancement streams in a storage medium, the different streams can be separately sent to a requesting playback device depending on the requirements of the playback device.

According to one embodiment of the invention, a method and apparatus for recording a data stream having a base stream and an enhancement stream on a storage medium for improving non-linear playback performance of the recorded data is disclosed. The data stream is received and I-pictures from the base stream are stored in a first buffer. All of the remaining data from the data stream is stored in a second buffer. Each time the first buffer becomes full, I-pictures stored in the first buffer are written onto an intra-coded allocation unit on the storage medium. The contents of second buffer are written onto at least one subsequent inter-coded allocation unit.

According to another embodiment of the invention, a method and apparatus for storing a data stream comprising a base stream and an enhancement stream on a storage medium comprising at least one base allocation unit and at least one enhancement allocation unit is disclosed. When the data stream is received, the base stream is stored in the base allocation unit on the storage medium, and the enhancement stream is stored in the enhancement allocation unit on the storage medium.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a layered video encoder according to one embodiment of the invention;

FIG. 2 illustrates a storage medium according to one embodiment of the invention;

FIG. 3 illustrates a block diagram of a audio-video apparatus suitable to host embodiments of the invention;

FIG. 4 illustrates a block diagram of a set-top box which can be used to implement at least one embodiment of the invention;

FIG. 5 illustrates a storage medium according to one embodiment of the invention;

FIG. 6 illustrates a recording apparatus according to one embodiment of the invention;

FIG. 7 is a flow chart which illustrates the storage of a data stream according to one embodiment of the invention;

FIG. 8 illustrates a storage medium according to one embodiment of the invention;

FIG. 9 illustrates a recording apparatus according to one embodiment of the invention; and

FIG. 10 is a flow chart which illustrates the storage of a data stream according to one embodiment of the invention.

### DETAILED DESCRIPTION OF THE INVENTION

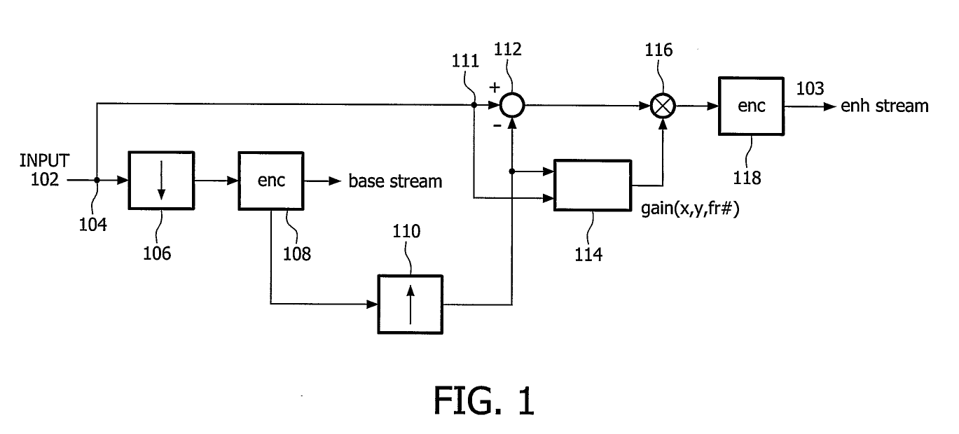

FIG. 1 is a block diagram of an exemplary layered video encoder/decoder 100 which can be used with the present invention. It will be understood by one skilled in the art that the present invention can be used with any layered video encoder which produces a base stream and at least one enhancement stream and the invention is not limited to the illustrative example described below.

The encoder/decoder 100 comprises an encoding section 101 and a decoding section. A high-resolution video stream 102 is inputted into the encoding section 101. The video stream 102 is then split by a splitter 104, whereby the video stream is sent to a low pass filter 106 and a second splitter 111. The low pass filter or downsampling unit 106 reduces the resolution of the video stream, which is then fed to a base encoder 108. The base encoder 108 encodes the downsampled video stream in a known manner and outputs a base stream 109. In this embodiment, the base encoder 108 outputs a local decoder output to an upconverting unit 110. The upconverting unit 110 reconstructs the filtered out resolution from the local decoded video stream and provides a reconstructed video stream having basically the same resolution format as the high-resolution input video stream in a known manner. Alternatively, the base encoder 108 may output an encoded output to the upconverting unit 110, wherein either a separate decoder (not illustrated) or a decoder provided in the upconverting unit 110 will have to first decode the encoded signal before it is upconverted.

The splitter 111 splits the high-resolution input video stream, whereby the input video stream 102 is sent to a subtraction unit 112 and a picture analyzer 114. In addition, the reconstructed video stream is also inputted into the picture analyzer 114 and the subtraction unit 112. The picture analyzer 114 analyzes the frames of the input stream and/or the frames of the reconstructed video stream and produces a numerical gain value of the content of each pixel or group of pixels in each frame of the video stream. The numerical gain value is comprised of the location of the pixel or group of pixels given by, for example, the x,y coordinates of the pixel or group of pixels in a frame, the frame number, and a gain value. When the pixel or group of pixels has a lot of detail, the gain value moves toward a maximum value of “1”. Likewise, when the pixel or group of pixels does not have much detail, the gain value moves toward a minimum value of “0”. Several examples of detail criteria for the picture analyzer are described below, but the invention is not limited to these examples. First, the picture analyzer can analyze the local spread around the pixel versus the average pixel spread over the whole frame. The picture analyzer could also analyze the edge level, e.g., abs of
−1−1−1
−1 8−1
−1−1−1
   per pixel divided over average value over whole frame.

The gain values for varying degrees of detail can be predetermined and stored in a look-up table for recall once the level of detail for each pixel or group of pixels is determined.

As mentioned above, the reconstructed video stream and the high-resolution input video stream are inputted into the subtraction unit 112. The subtraction unit 112 subtracts the reconstructed video stream from the input video stream to produce a residual stream. The gain values from the picture analyzer 114 are sent to a multiplier 116 which is used to control the attenuation of the residual stream. In an alternative embodiment, the picture analyzer 114 can be removed from the system and predetermined gain values can be loaded into the multiplier 116. The effect of multiplying the residual stream by the gain values is that a kind of filtering takes place for areas of each frame that have little detail. In such areas, normally a lot of bits would have to be spent on mostly irrelevant little details or noise. But by multiplying the residual stream by gain values which move toward zero for areas of little or no detail, these bits can be removed from the residual stream before being encoded in the enhancement encoder 118. Likewise, the multipler will move toward one for edges and/or text areas and only those areas will be encoded. The effect on normal pictures can be a large saving on bits. Although the quality of the video will be effected somewhat, in relation to the savings of the bitrate, this is a good compromise especially when compared to normal compression techniques at the same overall bitrate. The output from the multiplier 116 is inputted into the enhancement encoder 118 which produces an enhancement stream.

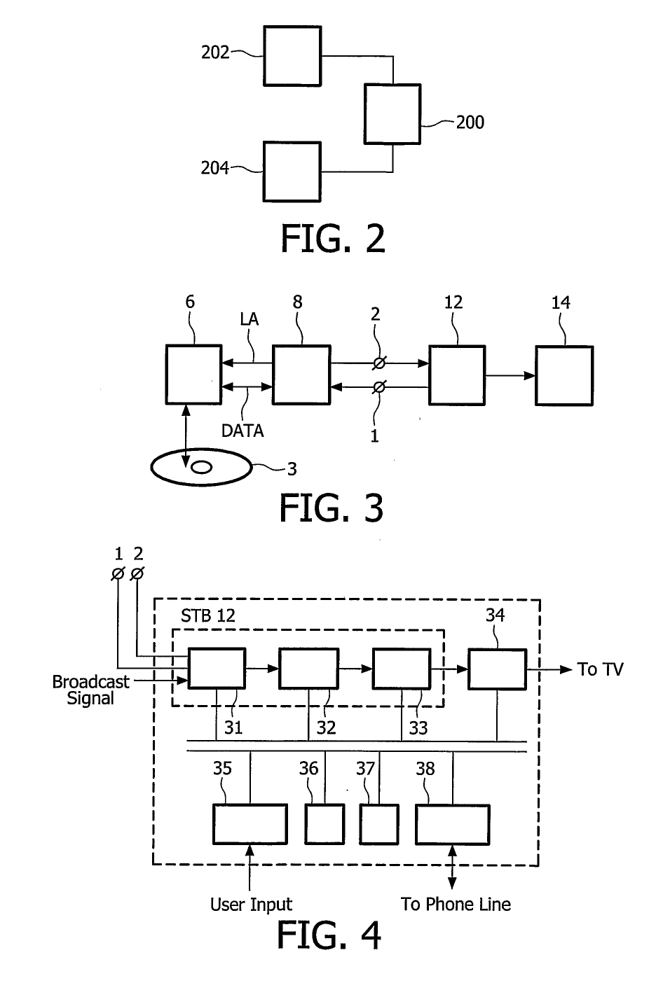

Once the base stream and the enhancement stream are produced, the streams can be sent to a storage medium for later recall. FIG. 2 illustrates a storage medium 200 according to one embodiment of the invention. At least one base allocation unit 202 is used to store the received base stream while at least one enhancement allocation unit 204 is used to store the received enhancement stream. It will be understood that the storage medium can be located in a variety of devices, e.g., a set-top box, portable display devices, etc. Although the term set-top box is used herein, it will be understood that this term refers to any receiver or processing unit for receiving and processing a transmitted signal and conveying the processed signal to a display device.

FIG. 3 illustrates and audio-video apparatus suitable to host the invention. The apparatus comprises an input terminal 1 for receiving a digital video signal to be recorded on a disc 3. Further, the apparatus comprises an output terminal 2 for supplying a digital video signal reproduced from the disc. These terminals may in use be connected via a digital interface to a digital television receiver and decoder in the form of a set-top box (STB) 12, which also receives broadcast signals from satellite, cable or the like, in MPEG TS format. While the MPEG format is being discussed, it will be understood by those skilled in the art that other formats with a similar IPB-like structure can also be used. The set-top box 12 provides display signals to a display device 14, which may be a conventional television set.

The video recording apparatus as shown in FIG. 3 is composed of two major system parts, namely the disc subsystem 6 and the video recorder subsystem 8, controlling both recording and playback. The two subsystems have a number of features, as will be readily understood, including that the disc subsystem can be addressed transparently in terms of logical addresses (LA) and can guarantee a maximum sustainable bit-rate for reading and/or writing data from/to the disc.

Suitable hardware arrangements for implementing such an apparatus are known to one skilled in the art, with one example illustrated in patent application WO-A-00/00981. The apparatus generally comprises signal processing units, a read/write unit including a read/write head configured for reading from/writing to disc 3. Actuators position the head in a radial direction across the disc, while a motor rotates the disc. A microprocessor is present for controlling all the circuits in a known manner.

Referring to FIG. 4, a block diagram of a set-top box 12 is shown. It will be understood by those skilled in the art that the invention is not limited to a set top box but also extends to a variety of devices such as a DVD player, PVR box, a box containing a Hard disk (recorder module), etc. A broadcast signal is received and fed into a tuner 31. The tuner 31 selects the channel on which the broadcast audio-video-interactive signal is transmitted and passes the signal to a processing unit 32. The processing unit 32 demultiplexes the packets from the broadcast signal if necessary and reconstructs the television programs and/or interactive applications embodied in the signal. The programs and applications are then decompressed by a decompression unit 33. The audio and video information associated with the television programs embodied in the signal is then conveyed to a display unit 34, which may perform further processing and conversion of the information into a suitable television format, such as NTSC or HDTV audio/video. Applications reconstructed from the broadcast signal are routed to random access memory (RAM) 37 and are executed by a control system 35.

The control system 35 may include a microprocessor, micro-controller, digital signal processor (DSP), or some other type of software instruction processing device. The RAM 37 may include memory units which are static (e.g. SRAM), dynamic (e.g. DRAM), volatile or non-volatile (e.g., FLASH), as required to support the functions of the set-top box. When power is applied to the set-top box, the control system 35 executes operating system code which is stored in ROM 36. The operating system code executes continuously while the set-top box is powered in the same manner as the operating system code of a typical personal computer and enables the set-top box to act on control information and execute interactive and other applications. The set-top box also includes a modem 38. The modem 38 provides both a return path by which viewer data can be transmitted to the broadcast station and an alternate path by which the broadcast station can transmit data to the set-top box.

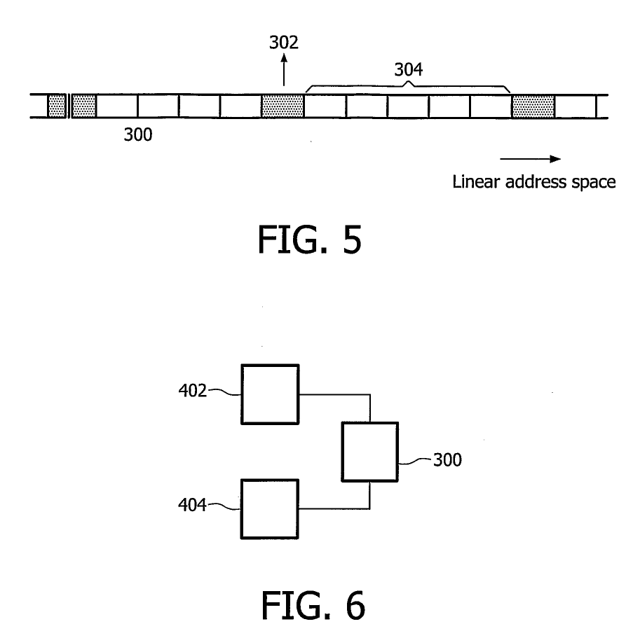

According to one embodiment of the invention, non-linear playback performance can be improved by dividing and storing different parts (I-pictures, B-pictures, P-pictures and other data) within each base stream and enhancement stream in different storage devices. Non-linear playback refers to trick play operations, e.g., fast forward and reverse, as well as playing back stored layered/scalable audio/video formats such as temporal, SNR and spatial scalability. This is achieved by allocating the I-pictures in separate allocation units on the disk at the time of recording. As illustrated in FIG. 5, intra-coded allocation units 302 are used for storing I-pictures from the base stream while inter-coded allocation units 304 are used to store I-pictures from the enhancement stream and B-, P-pictures and non-video data in both the base stream and the enhancement stream. The data in the intra-coded allocation units are coded with a first code and the data in the inter-coded allocation units are coded with a second code, wherein code refers to compression techniques and scalable/layered formats such as, for example, spatial and SNR coding. These separate intra- and inter-coded allocation units are written interleaved but preferably contiguously to a storage medium 300 which can be located in the set-top box (e.g. RAM 37) or external to the set-top box. Since the start and stop location of these I-pictures are already available from a CPI-extraction algorithm, this does not significantly add to the complexity of the recorder. As illustrated in FIG. 6, by separating the scheduler buffers for the I-pictures and the rest of the data, one intra-coded scheduler buffer 402 is used to store the I-pictures from the base stream and another inter-coded scheduler buffer 404 is used for the I-pictures from the enhancement stream and P- and B-pictures and non-video data in the base and enhancement streams.

As soon as one of the scheduler buffers in memory contains enough data to fill an entire allocation unit, the buffer content can be written to the storage medium 300. For a typical DVB stream with an average GOP-size c_{G}=390 kB and the I-picture size c_{I}=75 kB, it can be concluded that for the recorded DVB broadcast streams roughly every four to five allocation units will be inter-coded allocation units 304 on the storage medium 300. At the end of this specification, an illustrative algorithm is shown which re-interleaves the output of the separate buffers in to a single MPEG-stream, identical to the original stream, without the need for any a-priori knowledge, i.e., extra meta data, on the positions of individual pictures in the storage medium 300.

At normal play back speed, every intra-coded allocation unit 302 contains at least all of the I-pictures needed to decode the inter-coded pictures in all subsequent inter-coded allocation units 304 until the next intra-coded allocation unit 302. This guarantees that no extra jumping or seeking is required during normal play back of such streams. This is of particular importance when I-pictures would exceed allocation unit boundaries, and might either require the scheduler buffers to be slightly larger than twice the single buffer size or necessitates the use of a stuffing mechanism to fill up allocation units. Note that this implies that the allocation units contain an integral number of pictures. It will be understood by one skilled in the art that multiple intra-coded allocation units can be written before starting to write the associated inter-coded data and non-video data.

Using this allocation strategy during trick play, ensures that it is no longer necessary to perform a seek operation in between I-pictures and eliminates the need to read inter-coded data, which is not used during trick play operation, from the storage medium 300. Another advantage is that, during recording and normal play, there will not be any extra performance penalty since the intra-coded allocation units are interleaved with the inter-coded picture allocation units on the disc. In other words, no extra time-consuming seeking is used at record time and normal play back.

By using this allocation method, it should be noted that I-pictures do not necessarily start and end on program stream or transport stream packet boundaries. This requires processing of leading and trailing packets of every intra-coded picture and its neighboring inter-coded pictures. Since such start and end detection of pictures is already available in recorders in the form of CPI-extraction, the available functionality can be used to find these picture boundaries within the transport packet. Subsequently, stuffing in the adaptation field of the transport stream packet can be applied in order to remove unwanted residuals at recording time, wherein the extra required processing is minimal.

The fact that the intra-coded pictures are separately allocated on the storage medium has some other less obvious advantages. For example, the allocation makes it much easier to analyze the content, e.g., generating thumbnails, scene change detection and generating summaries, since I-pictures, which are often used for these purposes are no longer distributed over the storage medium. For conditional access (CA) systems, this separation can also be advantageous in the sense that different encryption mechanisms can be applied for intra- and inter-coded data. In such CA systems, I-pictures are sometimes stored in the clear, i.e., not encrypted, in order to facilitate trick play whereas the P- and B-pictures are stored encrypted.

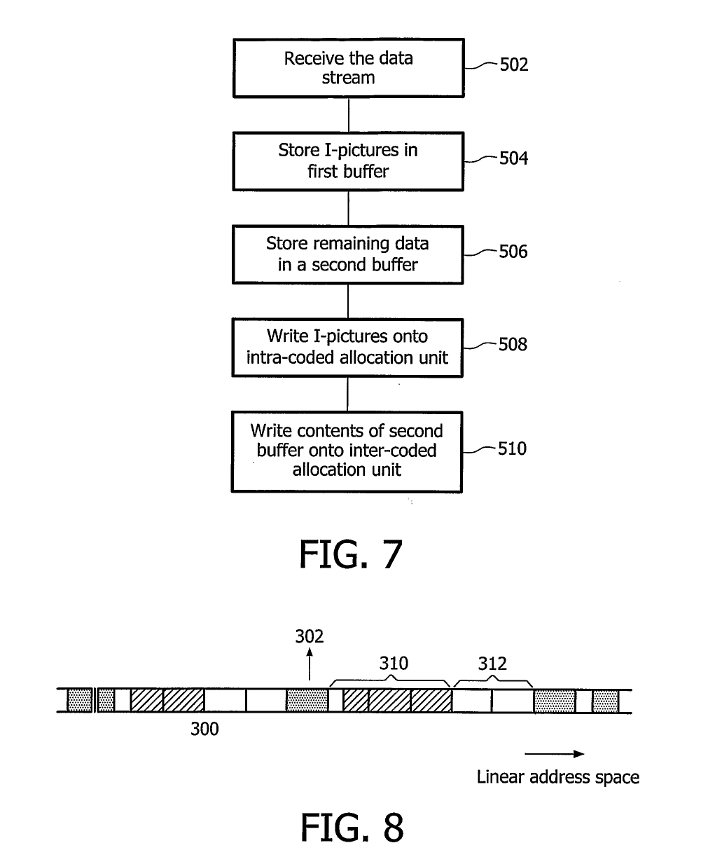

FIG. 7 is a flow chart which illustrates the storage and reading back of a data stream according the above-described embodiment of the invention. First, the data stream is received in step 502. The I-pictures from the data stream are then stored in a first buffer in step 504 and the remaining data from the data stream is stored in a second buffer in step 506. Each time the first buffer becomes full, the I-pictures stored in the first buffer are written onto an intra-coded allocation unit on the storage medium in step 508. Then, the contents of the second buffer are written onto preferably a subsequent inter-coded allocation unit in step 510.

According to another embodiment of the invention, the I-pictures from both the base stream and the enhancement stream can be stored together in the first buffer 402, while the P-pictures, B-pictures and non-video data from both streams are stored in the second buffer 404.

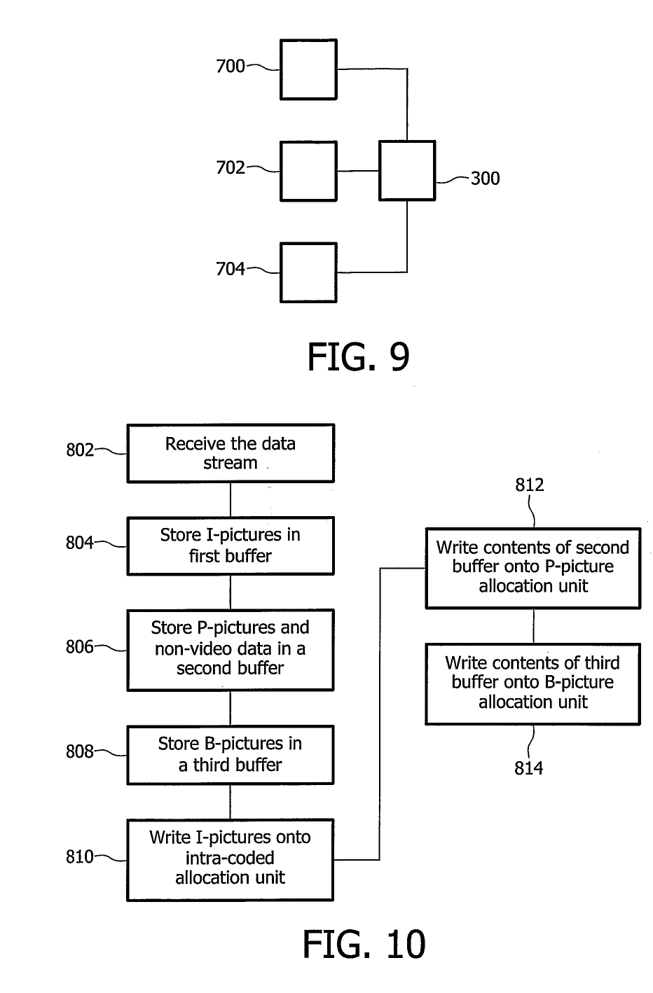

According to another embodiment of the invention, optimum allocation in combination with a very low complexity form of temporal scalability can be achieved. The temporal scalability is achieved by storing P- and B-pictures in separate allocation units on the storage medium, as illustrated in FIG. 8. In FIG. 8, each intra-coded allocation unit 302 is followed by at least one P-picture allocation unit 310 and at least one B-picture allocation unit 312. As illustrated in FIG. 9, three buffers are used for storing the data. A first buffer 700 stores the I-pictures of the base stream. A second buffer 702 stores the P-pictures and non-video data of the base stream in this example. A third buffer 704 stores the B-pictures in the base stream. The first buffer 700 can also be used to store the I-pictures of the enhancement stream. The second buffer 702 can also be used to store the P-pictures and non-video data of the enhancement stream in this example. The third buffer 704 can be used to store the B-pictures in the enhancement stream. No extra provisions in the encoder are required, i.e., it is compatible with existing codecs, to obtain this type of scalability. Scalability is of particular importance for mobile devices where power consumption constraints can prevail over video quality. Furthermore, this scalability can be extremely useful for networked devices where transport of video data over a digital interface with lower bandwidth than the actual video stream is required.

This temporal video scalability can be realized in two different ways. First, the frame refresh rate of the internal decoder can be reduced at play back, or in the case of play back over the digital interface, by inserting empty pictures at the position of skipped original pictures on play back to achieve effectively the same result. It should be noted that because this scalability does not influence the duration of the video on play back, the audio data is left unchanged and can therefore be decoded at the normal play back speed in sync with the video material. In order for this to work, all non-video data, e.g., audio data, private data, and SI-information is stored separately and preferably contiguously with respect to the I-picture allocation units either at the end of the I-picture allocation unit 302 or start of P-picture allocation units 310 as illustrated in FIG. 8.

Assuming that the macroblock throughput scales linearly with power consumption, the temporal scalability can lead to a reduction in power consumption of the video decoder by the respective sub sampling factors. Also less data needs to be retrieved, leading to another significant reduction in power consumption. By choosing a particular GOP structure, the granularity of the temporal scalability can be influenced. Note that by putting the B- and P-pictures into the same allocation units, a course form of the scalability (by a factor equal to the GOP-length N) can be achieved.

Using this allocation strategy not only reduces the required decoder power consumption but also leads to an optimum allocation in terms of power consumption for the storage engine. This is due to the fact that the allocation strategy guarantees that the number of medium accesses is minimized for different levels of granularity. In case of a mobile device running low on battery power where play back of the currently streaming video cannot be guaranteed, the power of the drive and decoder can be reduced to extend battery life. This type of allocation also improves performance for IPP based trick modes wherein allocation units are no longer polluted with unwanted B-pictures.

FIG. 10 is a flow chart which illustrates the storage and reading back of a data stream according the above-described embodiment of the invention. First, the data stream is received in step 802. The I-pictures from the data stream are stored in a first buffer in step 804. The P-pictures and non-video data from the data stream are stored in a second buffer in step 806. The B-pictures from the data stream are stored in a third buffer in step 808. Each time the first buffer becomes full, the I-pictures stored in the first buffer are written onto an intra-coded allocation unit on the storage medium in step 810. The contents of the second buffer are written into at least one P-picture allocation unit which typically follows the previously written intra-coded allocation unit in step 812. The contents of the third buffer are written into a B-picture allocation unit which follows the at least one P-picture allocation unit in step 814.

As an alternative, it is possible to store the audio and system information combined with empty pictures together in the I-pictures, P-pictures and B-pictures allocation units as well. In this illustrative example, the non-video data is duplicated three times, but the overhead is negligible. This offers the following three layers of operation. First, read I-pictures where the allocation units include added empty pictures with the non-video data interleaved. Note that all audio data is interleaved with I-pictures in the same allocation units. Second, read I-pictures and P-pictures and the non-video data is interleaved with the I- and P-pictures. On play back, the empty pictures in the I-picture section and the audio that is interleaved is skipped. This part is duplicated again with the P-pictures in such a way that on play back all audio data is available. Third, read I-pictures, P-pictures, B-pictures and the non-video data is interleaved with the I-, P-, B-pictures. The empty pictures in the I-picture and P-picture allocation units, and the non-video data interleaved with it, are skipped on play back. Again, the non-video data interleaved with the original I-, P- and B-pictures will result in the complete audio stream.

If properly structured, any of the above mentioned combinations can lead to a valid MPEG-stream, although some of the non-video data is duplicated and sometimes empty pictures are skipped on play back. For very low bit rates, temporal scalability is a nice type of scalability because it does not reduce the picture quality but only the picture refresh rate. Furthermore, a similar separation on the storage medium results in similar advantages for other types of layer compression formats, such as spatial and SNR scalability.

At normal speed play back, the intra- and inter-coded allocation blocks have to be re-multiplexed into a single MPEG-compliant video stream again. This can be done on the basis of the temporal references of the MPEG pictures, i.e., access units. A general algorithm to achieve this re-interleaving is given in the pseudo C-code below but the invention is not limited thereto:

While (“I-picture Buffer is not empty”
{

prev = −1
curr = “TemporalReference of first I-picture in buffer”
“Remove I-picture from buffer and send it over digital interface”
for (int I = prev + 1; I < curr; I++)

{

“remove B-picture from buffer and send it over digital interface”

}
while (“TemporalReference of next P-picture in buffer” > curr)
{

prev = curr;
curr = “ TemporalReference of first P-picture in buffer”
“Remove I-picture from buffer and send it over digital interface”
for (int I = prev + 1; I < curr; I++)

{

“remove B-picture from buffer and send it over digital interface”

}
}
}

The algorithm works for the two buffer embodiment (separate intra- and inter-coded buffers) as well as the three buffer (separate I-, P-, and B-picture buffers) embodiment. The variables “prev” and “curr” respectively denote the temporal references of the previous and current anchor pictures in the currently processed GOP. The only assumption is that at the start of processing, the read pointers in the three buffers are synchronized, i.e., all point to the correct corresponding entries.

Assuming that the first picture in the inter-coded block starts with the inter-coded picture immediately following the first I-picture of the intra-coded allocation unit, the system can reconstruct the original video stream without the need of any extra information as described above. For random access systems however, it might be required to add an extra field to the CPI-information table that contains a reference to the location of this inter-coded picture in order to be able to facilitate random access for I-pictures after the first I-picture of an allocation unit.

According to another embodiment of the invention, the three buffers illustrated in FIG. 9 can be used to store the data from the data stream in a different manner. In this illustrative example, the I-pictures from the base stream are stored in the first buffer 700. The I-pictures from the enhancement stream are stored in the third buffer 704, while the P-pictures, B-pictures and non-video data of both streams are stored in the second buffer 702.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A method for recording a data stream having a base stream and an enhancement stream on a storage medium comprising the steps of:
receiving the data stream;
storing I-pictures from the base stream in a first buffer;
storing all remaining data in a second buffer;
each time the first buffer becomes full, writing I-pictures stored in the first buffer onto an intra-coded allocation unit on the storage medium;
writing contents of second buffer onto at least one subsequent inter-coded allocation unit.

2. The method according to claim 1, wherein the remaining data from the data streams are I-pictures from the enhancement stream and P-pictures, B-picture and non-video data from both streams.

3. The method according to claim 2, wherein the non-video data comprises audio data, private data and system information.

4. The method according to claim 1, wherein the at least one inter-coded allocation unit contains P-picture, B-picture and non-video data associated with the I-pictures stored in the preceding intra-coded allocation unit.

5. The method according to claim 1, wherein non-video data is stored with the I-pictures.

6. The method according to claim 1, further comprising the steps of:
receiving a trick play request for the stored data;
reading the data in the intra-coded allocation units to create the requested trick play stream of recorded data.

7. The method according to claim 1, wherein data in the intra-coded allocation units are coded with a first code and the data in the inter-coded allocation units are coded with a second code.

8. The method according to claim 1, wherein the first buffer and second buffer are located in different sections of a single buffer.

9. The method according to claim 1, further comprising the steps of:
storing I-pictures from the enhancement stream in the first buffer;
storing all remaining data from the base and enhancement streams in the second buffer.

10. The method according to claim 1, further comprising the steps of:
storing I-pictures from the enhancement stream in a third buffer;
storing all remaining data from the base and enhancement streams in the second buffer.

11. A method for recording a data stream having a base stream and an enhancement stream on a storage medium comprising the steps of:
receiving the data stream;
storing I-pictures from the base stream in a first buffer;
storing P-pictures and non-video data from the base stream in a second buffer;
storing B-pictures from the base stream in a third buffer;
each time the first buffer becomes full, writing I-pictures stored in the first buffer onto an intra-coded allocation unit on the storage medium;
writing the contents of the second buffer into at least one P-picture allocation unit which is after the previously written intra-coded allocation unit;
writing the contents of the third buffer into at least one B-picture allocation unit which is after the at least one P-picture allocation unit.

12. The method according to claim 11, further comprising the steps of:
storing I-pictures from the enhancement stream in the first buffer;
storing P-pictures from the enhancement stream in the second buffer;
storing B-pictures from the enhancement stream in the third buffer.

13. An apparatus for recording a data stream having a base stream and an enhancement stream on a storage medium (300) comprising:
means for receiving (31) the data stream;
a first buffer (402) for storing I-pictures from the base stream;
a second buffer (404) for storing all remaining data from the data stream;
means for writing (6, 8) I-pictures stored in the first buffer onto an intra-coded allocation unit (302) on the storage medium each time the first buffer becomes full;
means for writing (6, 8) contents of second buffer onto at least one subsequent inter-coded allocation unit (304).

14. The apparatus according to claim 13, wherein I-pictures from the enhancement stream are stored in the first buffer and all remaining data from the base and enhancement streams are stored in the second buffer.

15. The apparatus according to claim 13, further comprising:
a third buffer (704) for storing I-pictures from the enhancement stream, wherein all remaining data from the base and enhancement streams are stored in the second buffer.

16. An apparatus for recording a data stream having a base stream and an enhancement stream on a storage medium (300) comprising:
means for receiving (31) the data stream;
a first buffer (700) for storing I-pictures from the base stream;
a second buffer (702) for storing P-pictures and non-video data from the base stream;
a third buffer (704) for storing B-pictures from the base stream;
means for writing (6, 8) I-pictures stored in the first buffer onto an intra-coded allocation unit (302) on the storage medium each time the first buffer becomes full;
means for writing (6, 8) the contents of the second buffer into at least one P-picture allocation unit (310) which is after the previously written intra-coded allocation unit;
means for writing (6, 8) the contents of the third buffer into at least one B-picture allocation unit (312) which is after the at least one P-picture allocation unit.

17. The apparatus according to claim 16, wherein I-pictures from the enhancement stream are stored in the first buffer, P-pictures from the enhancement stream are stored in the second buffer, and B-pictures from the enhancement stream are stored in the third buffer.

18. A method for storing a data stream comprising a base stream and an enhancement stream on a storage medium comprising at least one base allocation unit and at least one enhancement allocation unit, the method comprising the steps of:
receiving the data stream;
storing the base stream in the base allocation unit on the storage medium; and storing the enhancement stream in the enhancement allocation unit on the storage medium.

19. An apparatus for storing a data stream comprising a base stream and an enhancement stream on a storage medium comprising at least one base allocation unit and at least one enhancement allocation unit, comprising:
a receiver (31) for receiving the data stream;
means (35) for storing the base stream in the base allocation unit on the storage medium; and
means (35) for storing the enhancement stream in the enhancement allocation unit on the storage medium.

20. A storage medium, comprising:
at least one base allocation unit (402) for storing a base stream; and
at least one enhancement allocation unit (404) for storing an enhancement stream.

21. An apparatus for reading a data stream comprising a base stream and an enhancement stream from a storage medium having at least one base allocation unit (402) for storing the base stream and at least one enhancement allocation unit (404) for storing an enhancement stream and wherein the apparatus comprises:
a first reading unit for reading the base stream from the base allocation unit;
a second reading unit for reading the enhancement stream from the enhancement allocation unit (404);
a combining unit for combining the base stream with the enhancement stream in order to provide the data stream; and
a reproduction unit for reproducing the data stream.
